(19) United States
(12) Patent Application Publication
(10) Pub. No.: US 2021/0210951 A1
(43) Pub. Date: Jul. 8, 2021

(54) POWER DEVICE PROTECTION

(71) Applicant: HEWLETT-PACKARD DEVELOPMENT COMPANY, L.P., Spring, TX (US)

(72) Inventor: David E. SMITH, Vancouver, WA (US)

(73) Assignee: HEWLETT-PACKARD DEVELOPMENT COMPANY, L.P., Houston, TX (US)

(21) Appl. No.: 16/075,492

(22) PCT Filed: Apr. 25, 2017
(86) PCT No.: PCT/US2017/029277

§ 371 Date: Aug. 3, 2018

(51) Int. Cl. H02H 7/20; H02H 1/00

(52) U.S. Cl. CPC H02H 7/20; H02H 1/0007

(57) ABSTRACT

A power device protection system comprising a front-end monitoring device to acquire electrical operation data at an input side of a power supply circuit, a controller to receive the electrical operation data from the front-end monitoring device, wherein the controller determines an electrical parameter of the power supply circuit based on the electrical operation data and a load at the output side of the power supply circuit, and wherein the controller compares the determined electrical parameter of the power supply circuit and a threshold value associated with a defined operating condition.

### BACKGROUND

Power devices may comprise a large load connected to a power supply circuit that may consume a large electrical power. This large power comes along with specialized power device components adapted to these working conditions. Further, large electrical power can induce a potentially hazardous situation in the device, which should be avoided.

### BRIEF DESCRIPTION OF THE DRAWINGS

The following detailed description will best be understood with reference to the drawings, wherein:

FIG. 1 illustrates a schematic of a power device protection system according to an example.

FIG. 2 illustrates a schematic of a power device protection system according to a further example.

FIG. 3 illustrates a schematic of a power device protection system according to another example.

FIG. 4 illustrates a schematic of a power device protection according to yet another example.

FIG. 5 depicts a flow diagram for protecting a power device according to an example.

FIG. 6 illustrates a schematic of a power device protection including a circuit breaker according to an example.

FIG. 7 illustrates a schematic of a power device protection system including a back-end monitoring device according to another example.

FIG. 8 illustrates a schematic of a 3D printer according to an example.

FIG. 9 depicts a flow diagram of a method for protecting a power device according to an example.

FIG. 10 depicts a flow diagram of a method for protecting a power device according to another example.

### DETAILED DESCRIPTION

Power devices may comprise extensive circuitry for providing electrical power to an electrical load. To establish an electrical connection of the high-power device, several electrical conductors, including screw terminals can be used to connect different parts of the power supply circuitry. Long-term reliability depends on an initial torque applied to the screw and the electrical connection may suffer from degradation over time leading to loose connections. Such loose connections can be a fire hazard.

In the timeframe leading up to a hazardous situation, the loose connection first may cause oxidation of the wiring and therefore a local heat generation spot which in turn may increase the rate of oxide generation; ultimately a runaway situation with respect to generated heat can occur. The oxide may be associated with a change of an electrical parameter in the circuit, such as an increase of a resistance in the circuit.

Monitoring an electrical parameter may therefore allow detecting an abnormal operating condition and consequently may allow protecting the power device from a potentially hazardous situation.

To address these issues, in the examples described herein, a system and method for protecting a power device is provided.

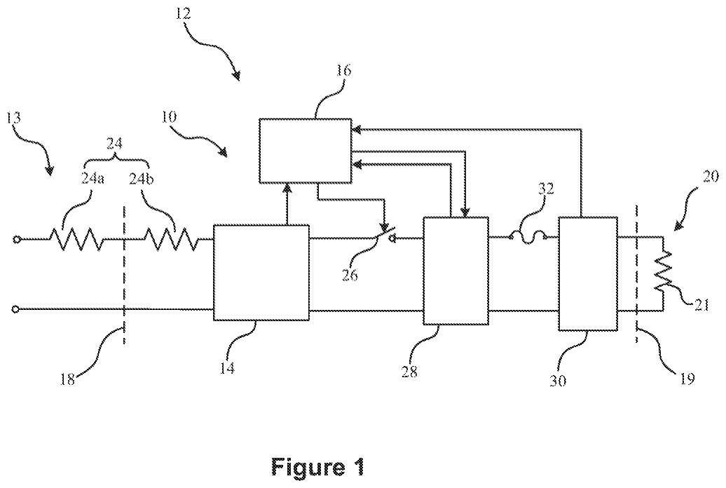

FIG. 1 shows a circuit schematic that includes an example of a power device protection system 10. The power device protection system 10 is part of a power supply circuit 12 which is connected to an AC mains output circuit 13. The AC mains output circuit 13 provides electrical power to the power supply circuit 12 via an electrical connection, such as a power cord.

The power device protection system 10 comprises a front-end monitoring device 14 and a controller 16 and is located between an input side 18 and an output side 19 of the power supply circuit 12.

The input side 18 of the power supply circuit 12 is connected to the AC mains output circuit 13, and the output side 19 of the power supply circuit 12 is connected to a load 20, which may comprise a resistor 21.

In the following, a flow of electrical energy (current) is assumed from the AC mains output circuit 13 towards the load 20, and the location of the devices may accordingly be specified in terms of the power flow direction, such as upstream or downstream.

Moreover, the term “located” refers to a position in an electrical circuit and may or may not be related to a physical location of the component. Rather, the term may specify an electrical connection configuration and relative spatial terms may refer to an arrangement of electrically interconnected parts in an electrical circuit.

Furthermore, the electrical connections of the AC mains output circuit 13 may be associated with a resistance 24a, and the electrical connections of the power supply circuit 12 from the input side 18 to the input of the front-end monitoring device 14 may be associated with a resistance 24b. The resistances 24a, 24b form part of a resistance 24 that is upstream of the input of the front-end monitoring device 14.

The front-end monitoring device 14 acquires electrical operation data at the input side 18 of the power supply circuit 12, and the electrical operation data is received by the controller 16. From the electrical operation data and information on the load 20, the controller 16 determines an electrical parameter of the power supply circuit 12. Furthermore, the controller 16 compares the determined electrical parameter of the power supply circuit 12 and a threshold value associated with a defined operating condition.

The power supply circuit 12 may further comprise a circuit breaker 26, a power converter 28, or a back-end monitoring device 30 located downstream of the front-end monitoring device 14. The controller 16 may control the circuit breaker 26 and/or the power converter 28. The power converter 28 may provide electrical power to the load 20. The controller 16 may further acquire electrical operation data from the back-end monitoring device 30 located at the output side 19 of the power supply circuit 12. In addition, the power supply circuit 12 may also comprise a fuse 32 as part of the power device protection system 10.

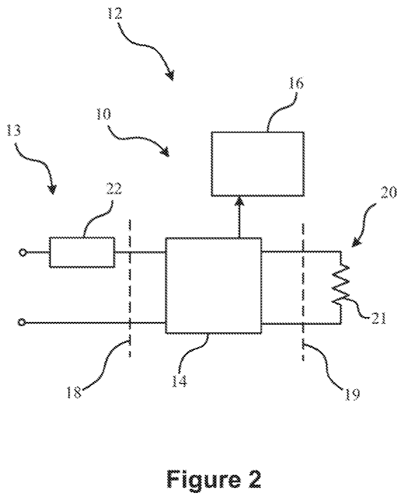

The power device protection system 10 is first explained with reference to an example illustrated in FIG. 2. In the example, the power device protection system 10 is comprised in the power supply circuit 12 and comprises the front-end monitoring device 14, and the controller 16. The front-end monitoring device 14 is arranged at the input side 18 of the power supply circuit 12 and acquires electrical operation data.

The electrical operation data may comprise a voltage, a current, an electric field, a magnetic field, combinations of these or other electrical operation data. The input side 18 of the power supply circuit 12 may be connected to an AC mains circuit, another power supply circuit or parts of a power supply circuit, an uninterruptible power supply, an electrical generator, or the like.

The controller 16 receives the electrical operation data from the front-end monitoring device 14. The controller 16 may be a microcontroller, an ASIC, a PLA (CPLA), a FPGA, or other control device, including control devices operating based on software, hardware, firmware, or a combination thereof. The controller 16 can include an integrated memory, or communicate with an external memory, or both and may further comprise terminals to be connected to sensors, devices, appliances, integrated logic circuits, other controllers, or the like, wherein the terminals may be configured to receive or send signals, such as electrical signals, optical signals, wireless signals, acoustic signals, or the like.

The controller 16 determines an electrical parameter 22 from the electrical operation data and the load 20 at the output side 19 of the power supply circuit 12.

The electrical parameter 22 may relate to a resistance, a voltage, a current, an electrical power, a capacitance, an inductance, or other derived or direct electrical parameter, or a combination thereof. In one example, the controller 16 may receive information on the load 20 connected to the power device protection system 10 from the load 20. In another example, the controller 16 may obtain information on the load 20 connected to the power device protection system 10 from the electrical operation data.

In FIG. 1, for the sake of clarity and convenience, the load 20 is depicted as comprising the resistor 21; however, any load 20 that draws electrical power from the power supply circuit 12 may be used. Examples for the load 20 may comprise a resistor, a power device, a part of a power device, a power supply, a heater or any other electrical appliance. The load 20 can also comprise a high-power load, such as a high-power heating device. Just as an example, the high-power heating device may be an infra-red lamp, a tungsten lamp, a filament based heating device, a thermal based curing device or any other heating device. The load 20 can further be a high-power load operating on an AC power supply that may have a frequency of 50 or 60 Hz. The load 20 may also have a high electrical power consumption, such as a power consumption higher than 1 kW or a power consumption in the range of 1 kW to 100 kW, or 2 kW to 50 kW, or 4 kW to 20 kW, to just give some examples, and the power consumption may temporarily be lower or higher.

The controller 16 further compares the determined electrical parameter 22 of the power supply circuit 12 and a threshold value associated with a defined operating condition.

The defined operating condition may relate to a state of the power supply circuit 12 or a state of the AC mains output circuit 13 connected to the input side 18 of the power supply circuit 12. However, the AC mains output circuit 13 may also be considered to be part of the power supply circuit 12. The power supply circuit 12 may then comprise a series of electrical connections connecting the power supply circuit 12 to a power supply such as an AC mains circuit, a generator, an uninterruptible power supply, another power supply circuit or the like.

The threshold value for the electrical parameter 22 of the power supply circuit 12 may be derived from a value that indicates an abnormal operating condition. The abnormal operating condition may be related to a potential safety hazard, such as a fire hazard. The threshold related to the abnormal operating condition may be an absolute value of the electrical parameter 22, or an increase or a decrease of the electrical parameter 22 with respect to a normal operating condition. The threshold related to the abnormal operating condition may be established by a standard, such as safety standard, or may be derived from a calibration of the power device protection system 10, or the power supply circuit 12, or the AC mains output circuit 13. In addition, the threshold value may (dynamically) depend on an electrical load of the power device, and may for example be derived from an electrical power consumption of the power supply circuit 12.

In an example, where the abnormal operating condition is related to a fire hazard, a threshold value may be related to an increase of the electrical power consumption of the power supply circuit 12 or the AC mains output circuit 13. Such an increase may be greater than a characteristic value of an electrical power that may be in the range of about 10 W to about 100 W. or about 20 W to about 60 W, or about 20 W to about 40 W, such as 20 W. This increase of the electrical power consumption may originate from an oxide layer at a loose connection and may be related to an increase of the electrical parameter 22, such as a resistance. However, the increase of the electrical power consumption may also originate from other sources, such as faulty wires or connections, or defective devices in the power supply circuit 12, just to give a few examples, and may further be identified with changes of other electrical parameters 22, such as an electrical power, an electrical conductivity, a capacitance, an inductance, or the like.

The increase of the electrical power consumption may result in a directly measurable change of the electrical operation data acquired by the front-end monitoring device 14, such as voltage sag at the input of the front-end monitoring device 14. The change of the electrical operation data may depend on the electrical power consumption of the load 20 at the output of the power supply circuit 12. The change of the electrical operation data acquired by the front-end monitoring device 14 may further be associated with other elements of the electrical operation data acquired by the front-end monitoring device 14, such as a current.

Relating the change of the electrical operation data to an electrical parameter can allow identifying a variance of the electrical operation data, such as a change of the input voltage due to variations of the voltage of the power grid. From the comparison of the threshold value and the determined electrical parameter 22, an abnormal operating condition, such as a potential fire hazard may therefore be detected reliably.

In some examples, the controller 16 may determine the electrical parameter 22 of the power supply circuit 12 from the change of the electric operation data received from the front-end monitoring device 14 and the electrical power consumption of the load 20, when the electrical power consumption of the load 20 changes.

In one approach, the front-end monitoring device 14 monitors a voltage at the input side of the power supply circuit 12 and, when the controller 16 determines a voltage drop at the input side 18 of the power supply circuit 12, the controller 16 triggers determination of the electrical parameter 22 of the power supply circuit 12. The voltage drop may be defined with respect to a measured voltage value at an initial point in time and may be related to a voltage rating of the power supply connected to the input side 18 of the power supply circuit 12, such as an AC voltage of an AC mains circuit, such as 220 V, 230 V, or 120 V, or a voltage of the industrial AC power connection, such as between 100 and 690V, or any other AC or DC voltage of any other electrical power supply circuit. The controller 16 may also store voltage data acquired form the front-end monitoring device 14 to track a change of the voltage drop over time.

In another approach, the front-end monitoring device 14 may also monitor the voltage or current at the input side 18 of the power supply circuit 12 in time series, and the controller 16 may continuously determine the electrical parameter 22 of the power supply circuit 12 based on the voltage or current in time series and the load 20 of the power supply circuit 12. The voltage or current in time series may refer to voltage or current values that were acquired or recorded at regularly or irregularly spaced points in time, such as equally spaced points in time, or points in time associated with an external or internal trigger condition.

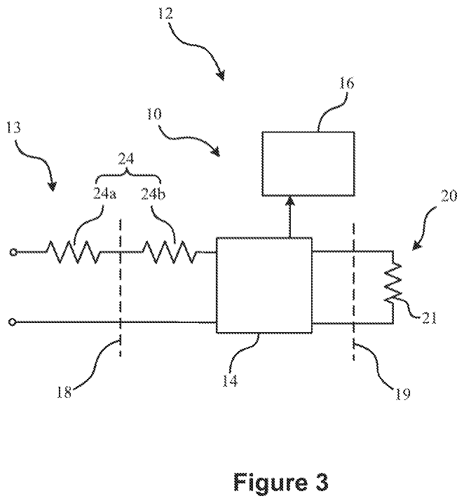

In one example illustrated in FIG. 3, the electrical parameter 22 comprises the resistance 24 that may be composed of a resistance 24a of the AC mains output circuit 13 and a resistance 24b of the power supply circuit 12. The resistance 24b of the power supply circuit 12 is located upstream of the input of the front-end monitoring device 14. The controller 16 may determine a value of the resistance 24 of the power supply circuit 12 from the electrical operating data, such as a voltage and a current acquired by the front-end monitoring device 14 for different electrical loads connected to the output side of the power supply circuit 12, such as two pairs of values for the voltage and the current at two different values of the electrical power consumption of the load 20. The different electrical loads connected to the output side of the power supply circuit 12 may be due to a periodic change of the electrical power consumption of the load 20. The different electrical loads may also be due to a change of a number of loads 20 connected to the output of the power supply circuit 12.

For example, in the case of the resistance 24 as the electrical parameter 22 or as part of the electrical parameter 22, an increase of the electrical power consumption of the power supply circuit 12 may be associated with a change of the resistance 24 according to the equation:

$$R = \frac{P}{{I}^{2}} ,$$

wherein P is the electrical power consumption, I is the current carried by the power supply circuit 12, and R is a resistance value. However, any derived parameter using any other electrical parameter may be used to relate an increase of the electrical power consumption to the electrical parameter 22, such as a voltage instead of a current, just to give an example.

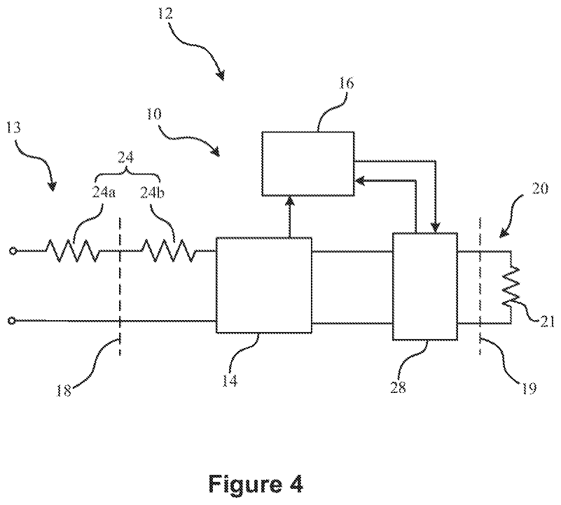

In an example shown in FIG. 4, the controller 16 may also control the load 20. The controller 16 may thereby control the electrical power consumption of the load 20, change the number of loads 20 connected to the output of the power supply circuit 12, or acquire information about electrical operation data from the load 20. When the controller 16 controls the load 20, the controller 16 can trigger the determination of the electrical parameter 22 of the power supply circuit 12.

In some examples, the power supply circuit 12 may also comprise the power converter 28 that supplies electrical power to the load 20 and that is located between the output side 19 of the power supply circuit 12 and the front-end monitoring device 14. Moreover, the controller 16 may control the load 20 by sending instruction signals to the power converter 28. The controller 16 may also acquire status information from the power converter 28 that may be used to determine the electrical parameter 22.

The power converter 28 may be a (mains) power supply, an inverter, a converter, a regulator, a transformer, a rectifier, or any other suitable device for controlling and/or converting electrical power that is supplied to the load 20.

In one example, the controller 16 controls the load 20 at the output side 19 of the power supply circuit 12 and, when the controller 16 determines a voltage drop in the voltage at the input side 18 of the power supply circuit 12, the controller 16 reduces the load 20 at the output side 19 of the power supply circuit 12 and again determines the voltage at the input side 18 of the power supply circuit 12 to determine the resistance 24 of the power supply circuit 12. However, the controller 16 may also increase the load 20 to determine the electrical parameter 22 of the power supply circuit 12.

In addition, when the controller 16 determines that the electrical parameter 22 exceeds the threshold value, the controller 16 may generate an abnormal operating condition signal. The abnormal operating condition signal may be sent via a terminal of the controller 16 to another controller, an ASIC, an interconnecting device, a telecommunication link, or the like, or may generate an audiovisual signal in proximity to the power device protection system 10, such as a light signal or an audible signal, or may induce the display of an error signal at an interface of the power device protection system 10, the power device, a distant monitoring device, or the like. The abnormal operating condition signal may further comprise information for a service technician.

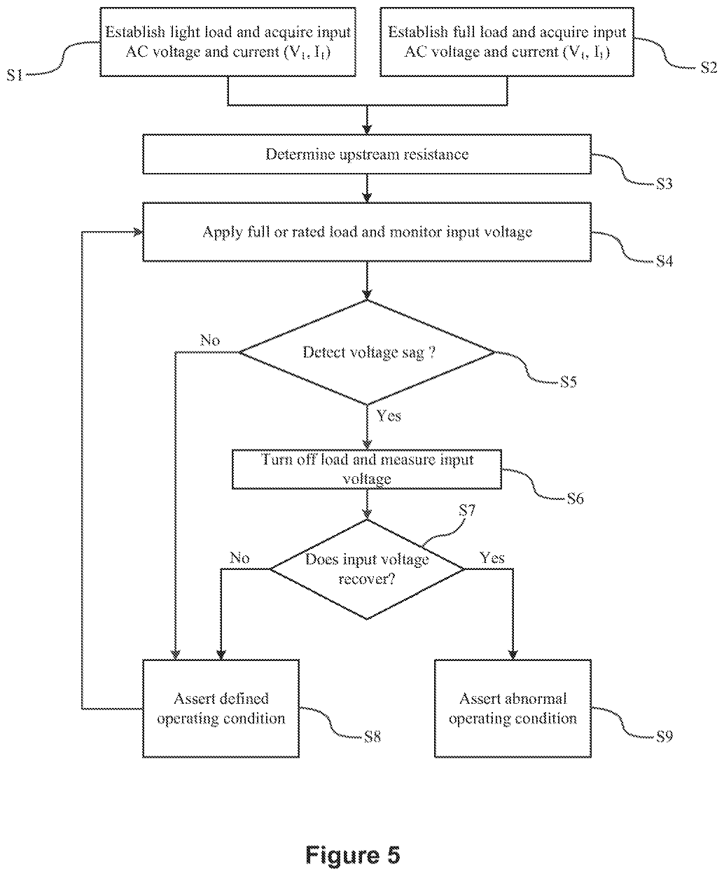

To illustrate a possible example of the power device protection system 10, a flowchart is provided in FIG. 5. In the example, the input of the power circuit 12 may be connected to an AC mains circuit with a voltage rating of 230 V and the load 20 may draw a current that is detected by the front-end monitoring device 14.

In an initial calibration stage, the controller 16 establishes S1 a light load, such as a current of 1 A at the load 20, and acquires voltage and current data (V₁,I₁) from the front-end monitoring device 14. Then, the controller 16 establishes S2 full or rated load, such as a current of 20 A at the load 20, and again acquires voltage and current data (V₂,I₂) from the front-end monitoring device 14. The controller 16 then determines S3 a resistance value R of the resistance 24 according to

$$R = \frac{{V}_{2} - {V}_{1}}{{I}_{2} - {I}_{1}} .$$

The controller 16 then applies S4 full or rated load and monitors the input voltage at the input side 18 of the power supply circuit 12.

When the controller 16 detects S5 that a voltage sag with respect to a previously measured AC mains voltage remains within a threshold margin of the input voltage, the controller may assert S8 a defined operating condition and the power device may continue its operation. The threshold margin may be derived from an expected voltage sag due to a product of the resistance R and an instantaneous (varying) current drawn by the load, or may include common fluctuations of the input voltage.

When a defined operating condition is asserted 38, the controller 16 may continue applying S4 full or rated load and monitor the input voltage at the input side 18 of the power supply circuit 12.

When the controller 16 detects S5 that a voltage sag with respect to a previously measured AC mains voltage has increased by, for example, 1 V, the controller 16 reduces the current drawn by the load 20, such as turning off S6 the load 20, and again measures the input voltage. Depending on the value, the controller 16 decides S7 on the state of the defined operating condition, if the voltage drop was caused by the AC mains, the voltage will remain low even when the load 20 is reduced (No branch) and the voltage sag will be accounted for by the product of the reduced current and the previously determined resistance R. The controller 16 therefore asserts S8 the defined operating condition. If, however, the voltage drop was caused by an increase of the resistance 24, e.g. due to a loose connection, the front end voltage will (fully) recover when the load 20 is reduced (Yes branch), and the controller 16 asserts S9 an abnormal operating condition.

The controller 16 may also receive the input voltage from the front-end monitoring device 14 for both conditions of the load 20 and determine a value of the resistance 24 of the power supply circuit 12. When the value of the resistance 24, with respect to a previously measured resistance value R of the resistance 24, has increased by more than the threshold value associated with a potential fire hazard, such as for example 50 m, the controller 16 identifies an abnormal operating condition and generates an abnormal condition signal.

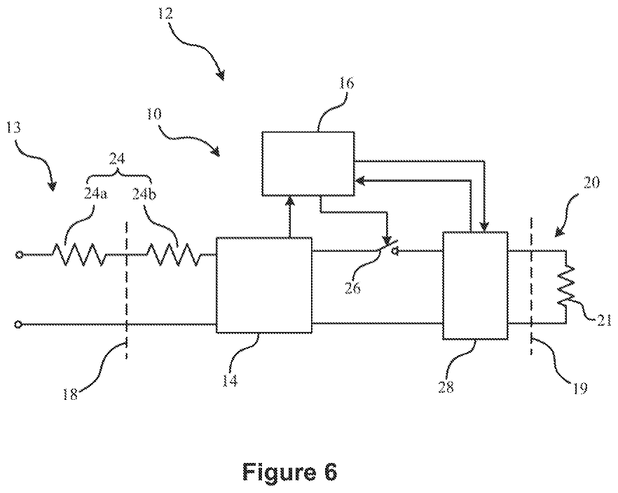

As illustrated in FIG. 6, the power device protection system 10 may also comprise the circuit breaker 26 located between the front-end monitoring device 14 and the load 20 of the power supply circuit 12. The circuit breaker 26 may be an electrical or mechanical switch, a fuse, an automatic circuit breaker or similar apparatus that can disrupt the transmission of electrical power from the input side 18 to the output side 19 of the power supply circuit 12.

The circuit breaker 26 may also be controlled by the controller 16, such that a signal sent by the controller 16 may open or close a switch comprised in the circuit breaker 26 and thereby disrupt the transmission of electrical power.

In one example, the controller 16 opens the circuit breaker 26 when the controller 16 determines that the electrical parameter 22 exceeds the threshold value. The controller 16 may also contain a first and a second threshold value, wherein the first threshold value may be related to a warning condition and the second threshold value may be related to a danger condition. In the case of a warning condition, the controller 16 may generate an abnormal condition signal. In the case of a danger condition, the controller 16 may open the circuit breaker 26. However, any number of threshold values and associated conditions may be used.

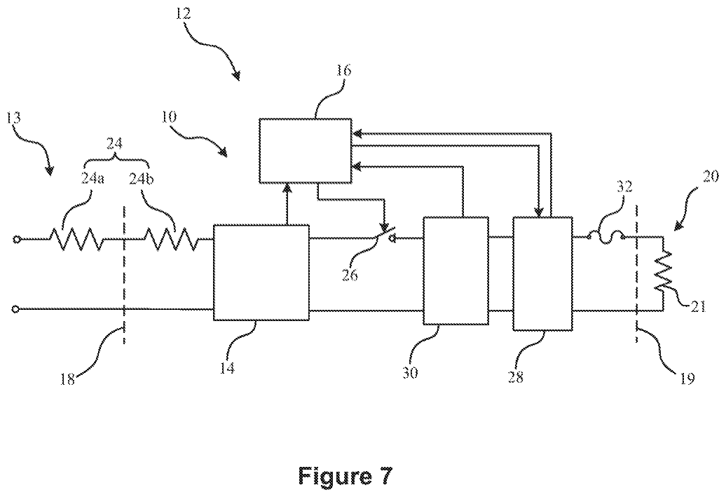

As illustrated in an example in FIG. 7, the power device protection system 10 may also comprise the back-end monitoring device 30 for measuring a voltage or a current, wherein the back-end monitoring device 30 is located between the circuit breaker 26 and the load 20 of the power supply circuit 12.

The back-end monitoring device 30 may be used to assert a working condition of a component of the power supply circuit 12 located downstream of the front-end monitoring device 14. The back-end monitoring device 30 may acquire a voltage or a current and generate electrical operation data that is received by the controller 16. From the electrical operation data, the controller 16 may then determine the working condition or an operation state of components of the power supply circuit 12, wherein the circuit breaker 26 is one example of components of the power supply circuit 12.

For example, when the circuit breaker 26 has been opened by the controller 16, the controller 16 receives electrical operation data from the back-end monitoring device 30 and verifies that no current is flowing, or that no voltage is applied to the input of the back-end monitoring device 30. Furthermore, when the circuit breaker 26 has been closed by the controller 16, the controller 16 verifies that a voltage is applied to the inputs of the back-end monitoring device 30.

In addition, the power device protection system 10 may also comprise the fuse 32. The fuse may protect the power device from an abnormal electrical condition, such as a high voltage or a high current, due to, for example, a malfunction of a component of the power supply circuit 12.

Referring back to the example illustrated in FIG. 1, the power converter 28 may also be located between the back-end monitoring device 30 and the front-end monitoring device 14.

The controller 16 may compare electrical operation data acquired from the front-end monitoring device 14 and electrical operation data acquired from the back-end monitoring device 30 to assert a working condition or operating state of the power converter 28. For example, the controller 16 may verify that a ratio of the voltage and current product measured by the front-end monitoring device 14 and the back-end monitoring device 30 is within a pre-calibrated range. This configuration may also be used to detect a change of an electrical parameter, such as a resistance within components of the power supply circuit 12 downstream of the front-end monitoring device 14, such as the power converter 28 or the power device protection system 10, in a manner analogous to the use of the front-end monitoring device 14 for determining the resistance value of the resistance 24 upstream of the front-end monitoring device 14.

In this case, the back-end monitoring device 30 may acquire electrical operation data which is received by the controller 16. The acquired electrical operation data is used by the controller 16 to determine a second electrical parameter. The controller 16 may then compare the second electrical parameter to a threshold value associated with an abnormal working condition related to the power supply circuit 12 downstream of the front-end monitoring device 14. A potentially hazardous working condition may therefore be identified in different parts of the electrical circuit.

When the controller 16 controls the load 20, the controller 16 may verify that the electrical operation data acquired from the back-end monitoring device 30 matches an intended electrical operation condition for the load 20 that was established by the controller 16, such as an intended electrical power, to assert a normal working condition.

In another example, the power device protection system 10 is embedded in a power device, such as a 3-D printer. 3-D printers construct a three-dimensional form according to a three-dimensional design out of a 3-D build material.

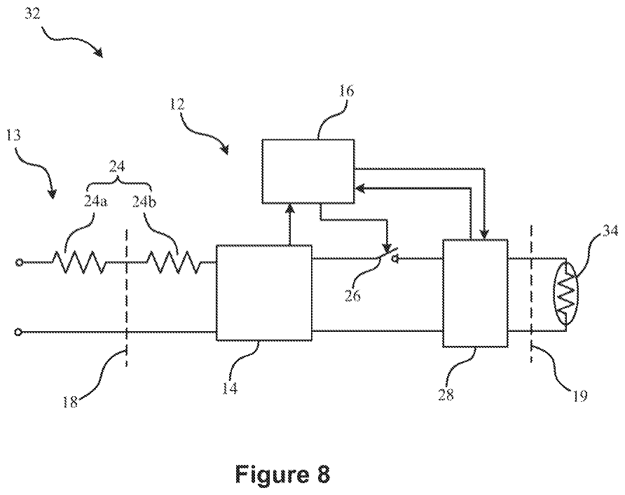

A 3-D printer 32 is schematically illustrated in FIG. 8 and comprises a power supply circuit 12, a controller 16 and a heater 34, the power supply circuit 12 comprising a front-end voltage and current monitoring device 36 to acquire electrical operation data at an input side 18 of the power supply circuit 12.

The heater 34 may be used to change the temperature of a substrate that is printed on or the temperature of a 3-D build material used for printing. Such a material may be a thermoplastic, a metal or a curable resist, resin, or plaster, although any suitable material for 3-D printing may be used. The heater 34 may be an infra-red lamp, a filament based heating device, a thermal based curing device or any other heating device. For example, the heater 34 may comprise a tungsten lamp. However, the heater 34 may also be a high-power light source, such as a laser, used for sintering a metal powder. In the case that the material is a curable resist, resin, or plaster, the heater 34 may be replaced with a light source used to locally excite and thereby cure the material.

The controller 16 receives the electrical operation data from the front-end voltage and current monitoring device 36 and controls the heater 34, for example via controlling a power converter 28. The controller 16 also determines an electrical parameter 22, such as a resistance value of the resistance 24 of the power supply circuit 12, based on the electrical operation data, and the controller 16 compares the determined electrical parameter 22 of the power supply circuit 12 and a threshold value associated with a defined operating condition.

To determine the electrical parameter 22, the 3-D printer 32 may, for example, periodically cycle the electrical load on the heater 34. The controller 16 may therefore determine the electrical parameter 22, such as the resistance value of the resistance 24, from the different load conditions during the different cycling steps and the electrical operation data acquired from the voltage and current monitoring device 36, similar to the power device protection system 10.

The cycling of the load on the heater 34 may be related to a process flow of the 3-D printer 32. The 3-D printer 32 may first deposit a build material, whereon the 3-D printer 32 deposits a patterned curing layer, such as a developer. The heater 34 may then be set to a high load condition, such that the temperature of the build material is raised. A positive or negative image of the pattern of the patterned curing layer may then be transferred to the build material. The heater 34 may then be set to a lower load condition to reduce the temperature of the heater 34 and to deposit a further layer of build material. For example, the 3-D printer 32 may cycle the load the heater 34 with a periodicity of three seconds to form a single layer of a plurality of layers of the three-dimensional form.

The 3-D printer 32 may then determine the resistance value of the resistance 24 with the same periodicity, or a multiple of the periodicity of the cycling of the heater 34, such as during every cycle of the load of the heater 34.

In FIG. 8, the electrical parameter 22 is depicted as the resistance 24. The resistance 24 may comprise the resistance 24a of the AC mains output circuit 13 and the resistance 24b of the power supply circuit 12 upstream of the front-end voltage and current monitoring device 36. The 3-D printer 32 may thereby detect an abnormal operating condition at any point of the electrical circuit upstream of the voltage and current monitoring device 36. In an example, wherein the abnormal operating condition is a potential fire hazard due to a loose connection, the 3-D printer 32 may thereby detect a loose connection either within the power supply circuit 12 or in the AC mains output circuit 13.

The 3-D printer 32 may further comprise a circuit breaker 26 to be opened by the controller 16 in response to a result of a comparison of the determined electrical parameter 22 and the threshold value to protect the 3-D printer 32 from the potential fire hazard.

In one example, the front-end voltage and current monitoring device 36 monitors a voltage at the input side 18 of the power supply circuit 12 and, when the controller 16 determines a voltage drop at the input side 18 of the power supply circuit 12, the controller 16 reduces the electrical load of the heater 34 at the output side 19 of the power supply circuit 12 and again determines the voltage at the input side 18 of the power supply circuit 12 to determine the resistance 24 of the power supply circuit 12.

The 3-D printer 32 may further comprise any additional system components, or system configurations, or component configurations of the power device protection system 10 described above.

The power device may also be protected from a potentially hazardous situation using a method for protecting a high-power device.

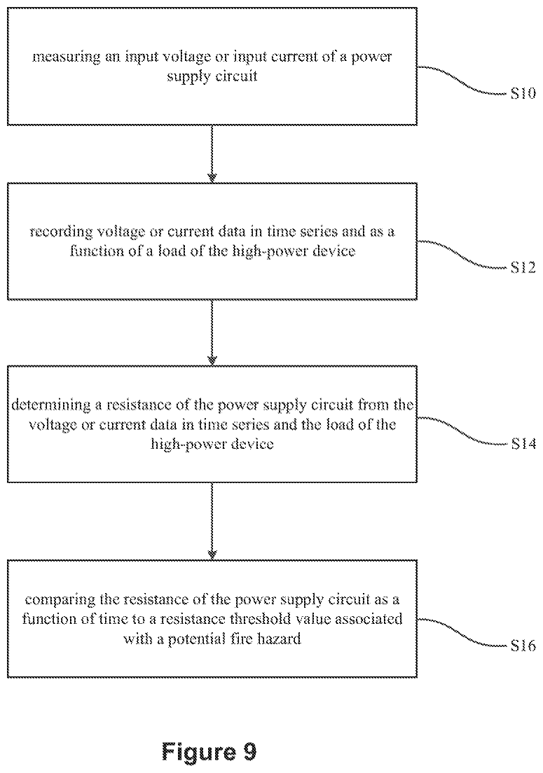

FIG. 9 illustrates a flow diagram of an example of the method for protecting a high-power device from a potential fire hazard comprising measuring S10 an input voltage or input current of a power supply circuit 12, recording S12 voltage or current data in time series and as a function of a load 20 of the high power device, determining S14 a resistance 24 of the power supply circuit 12 from the voltage or current data in time series and the load 20 of the high power device, and comparing S16 the resistance 24 of the power supply circuit 12 as a function of time to a resistance threshold value associated with the potential fire hazard. The order of the instructions is hereby not considered to impose any temporal order that they have to be performed in. For example, all the instructions may be performed simultaneously or may be performed in any suitable order, such as performing the determining S14 of the resistance 24 or the comparing S16 of the resistance 24 before the recording S12 of the voltage or current data in time series.

The voltage or current data in time series may relate to voltage or current data that is acquired at equally spaced points in time or that is acquired at a point in time that is triggered by a condition that may depend on the load 20, the voltage or current data or an external trigger. When the load 20 changes in time, voltage or current data that is acquired at equally spaced points in time may allow determining S14 the resistance 24 of the power supply circuit 12.

Further, the method may comprise controlling the load 20 of the high power device to determine the resistance 24 of the power supply circuit 12.

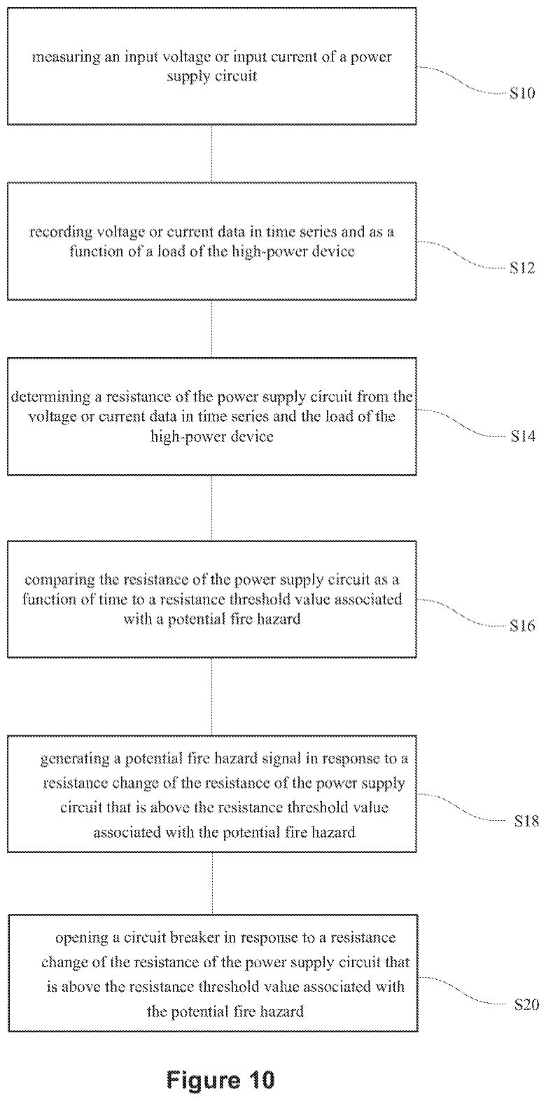

FIG. 10 depicts a flow diagram of another example of the method for protecting a high-power device from a potential fire hazard additionally comprising generating S18 a potential fire hazard signal in response to a resistance change of the resistance 24 of the power supply circuit 12 that is above the resistance threshold value associated with the potential fire hazard. The potential fire hazard signal may be an abnormal operating condition signal as described above, and may comprise generating audiovisual indicators.

In FIG. 10, the flow diagram of the example of the method for protecting a high-power device from a potential fire hazard additionally comprises opening S20 a circuit breaker 26 in response to a resistance change of the resistance 24 of the power supply circuit 12 that is above the resistance threshold value associated with the potential fire hazard.

In the method for protecting a high-power device from the potential fire hazard, different resistance thresholds may be associated with generating S18 the potential fire hazard signal and opening S20 the circuit breaker 26. For example, when the resistance change exceeds a first resistance threshold, such as a warning condition resistance threshold, a potential fire hazard signal may be generated and when the resistance change exceeds the second resistance threshold, such as a critical resistance threshold, the circuit breaker 26 may be opened. However, generating S18 the potential fire hazard signal and opening S20 the circuit breaker 26 may also be performed simultaneously and the resistance thresholds may have the same value.

Furthermore, generating S18 the potential fire hazard signal or opening S20 the circuit breaker 26 may also be implemented in the method independently, such as performing one of generating S18 the potential fire hazard signal and opening S20 the circuit breaker 26.

In addition, the method for protecting the high-power device from the potential fire hazard may comprise supplying electrical power to the high-power device. Moreover, the method may comprise controlling a power converter 28 of the power supply circuit 12 connected to the load 20 and supplying electrical power to the power device.

Further, the method for protecting a high-power device from a potential fire hazard may comprise detecting a voltage sag of the input voltage, and reducing the load 20 of the high-power device in response to the voltage sag of the input voltage. Reducing the load of the high-power device and recording voltage or current data before and after reducing the load 20 may allow determining the resistance 24 of the power supply circuit 12 at a specified point in time. The voltage sag may be used as an indicator that triggers determining the resistance 24 of the power supply circuit 12 at the specified point in time.

Additionally, the method for protecting the high-power device from the potential fire hazard may also implement additional instructions for controlling and monitoring the systems or high-power devices described above or may comprise instructions implementing the functionality of components of the systems or high-power devices described above.

Moreover, the figures and detailed description merely serve to illustrate aspects of the present disclosure and are not meant to limit the scope of protection. The scope of protection is to be determined solely by the appended claims.

What is claimed:

1. A power device protection system comprising:
a front-end monitoring device to acquire electrical operation data at an input side of a power supply circuit;
a controller to receive the electrical operation data from the front-end monitoring device;
wherein the controller determines an electrical parameter of the power supply circuit based on the electrical operation data and a load at the output side of the power supply circuit, and
wherein the controller compares the determined electrical parameter of the power supply circuit and a threshold value associated with a defined operating condition.

2. The system of claim 1, wherein the electrical parameter is a resistance of the power supply circuit.

3. The system of claim 2, wherein the front-end monitoring device monitors a voltage at the input side of the power supply circuit and, when the controller determines a voltage drop at the input side of the power supply circuit, the controller triggers determination of the resistance of the power supply circuit.

4. The system of claim 2, wherein the controller controls the load at the output side of the power supply circuit and, when the controller determines a voltage drop in the voltage at the input side of the power supply circuit, the controller reduces the load at the output side of the power supply circuit and again determines the voltage at the input side of the power supply circuit to determine the resistance of the power supply circuit.

5. The system of claim 2, wherein, when the controller determines that the electrical parameter exceeds the threshold value, the controller generates an abnormal operating condition signal.

6. The system of claim 2, wherein the front-end monitoring device monitors in time series the voltage at the input side of the power supply circuit, and the controller determines the resistance of the power supply circuit based on the voltage in time series and the load of the power supply circuit.

7. The system of claim 2 further comprising:
a circuit breaker located between the front-end monitoring device and the load of the power supply circuit.

8. The system of claim 7, wherein the controller opens the circuit breaker when the controller determines that the electrical parameter exceeds the threshold value.

9. The system of claim 7 further comprising:
a back-end monitoring device for measuring a voltage or a current and located between the circuit breaker and the load of the power supply circuit; and
wherein the controller monitors the operating state of the circuit breaker by acquiring electrical operation data from the back-end monitoring device.

10. The system of claim 5, wherein the abnormal operating condition indicates a potential fire hazard.

11. A 3D printer, including
a power supply circuit, a controller and a heater,
the power supply circuit having a front-end voltage and current monitoring device to acquire electrical operation data at an input side of the power supply circuit;
the controller receiving the electrical operation data from the front-end voltage and current monitoring device and controlling the heater;
wherein the controller determines an electrical parameter of the power supply circuit based on the electrical operation data, and
wherein the controller compares the determined electrical parameter of the power supply circuit and a threshold value associated with a defined operating condition to assert an operating state of the power device.

12. The 3D printer of claim 12, wherein the heater comprises a tungsten lamp.

13. The 3D printer of claim 12, wherein the front-end voltage and current monitoring device monitors a voltage at the input side of the power supply circuit and, when the controller determines a voltage drop at the input side of the power supply circuit, the controller reduces the heater load at the output side of the power supply circuit and again determines the voltage at the input side of the power supply circuit to determine the resistance of the power supply circuit.

14. A method for protecting a high-power device from a potential fire hazard comprising:
measuring an input voltage or input current of a power supply circuit;
recording voltage or current data in time series and as a function of a load of the high-power device;
determining a resistance of the power supply circuit from the voltage or current data in time series and the load of the high-power device; and
comparing the resistance of the power supply circuit as a function of time to a resistance threshold value associated with a potential fire hazard to identify an operating condition of the power device.

15. The method of claim 14 further comprising:
detecting a voltage sag of the input voltage; and
reducing the load of the high-power device in response to the voltage sag of the input voltage for determining the resistance of the power supply circuit.
